(19) United States
(12) Patent Application Publication
(10) Pub. No.: US 2018/0259544 A1
(43) Pub. Date: Sep. 13, 2018

(54) Robotic Device with Machine Vision and Natural Language Interface for Automating a Laboratory Workbench

(71) Applicant: aBioBot, Inc., Dublin, OH (US)

(72) Inventors: Raghu K. MACHIRAJU, Dublin, OH (US); Chaitanya KULKARNI, Columbus, OH (US)

(21) Appl. No.: 15/911,976

(22) Filed: Mar. 5, 2018

Related U.S. Application Data
(60) Provisional application No. 62/468,514, filed on Mar. 8, 2017.

(51) Int. Cl. G01N 35/00; G06F 17/27; G06K 9/00; G01N 35/10; B01L 3/02; B01L 9/00; B25J 9/00; B25J 9/16

(52) U.S. Cl. CPC G01N 35/0099; G06F 17/2785; G06K 9/00664; G01N 35/00722; G01N 35/1016; H04N 5/2253; G01N 35/1011; B01L 9/54; B25J 9/0096; B25J 9/1697; B01L 3/021

(57) ABSTRACT

The invention comprises a robotic device that automates certain functions of the laboratory workbench, such as drawing liquid from one or more reservoirs, depositing the liquid in one or more wells, discarding a used pipette tip, and adding on a new pipette tip. The device is equipped with cameras and a machine vision module which enable it to identify and categorize all objects on a workbench and to determine if a foreign or unknown object has entered the workbench during operation and to issue an alert. The device is also equipped with additional sensors to allow for accurate and robust operation and provide alerts for other operational mishaps. The invention further comprises a computing device that receives natural language instructions from a user, translates the instructions into a middleware language, and then compiles them into device-specific control instructions which it provides to the robotic device.

### PRIORITY CLAIM

This application claims the benefit of U.S. Provisional Application No. 62/468,514, filed on Mar. 8, 2017, and titled “Robotic Device with Machine Vision and Natural Language Interface for Automating a Laboratory Workbench,” which is incorporated herein by reference.

### TECHNICAL FIELD

The invention comprises a robotic device that automates certain functions of the laboratory workbench, such as drawing liquid from one or more reservoirs, depositing the liquid in one or more wells, discarding a used pipette tip, and adding on a new pipette tip. The device is equipped with cameras and a machine vision module which enables it to identify and categorize all objects on a workbench and to determine if a foreign or unknown object has entered the workbench during operation and to issue an alert. The invention further comprises a computing device that receives natural language instructions from a user, translates the instructions into a middleware language, and then compiles them into device-specific control instructions which it provides to the robotic device.

### BACKGROUND OF THE INVENTION

Biotechnology is a burgeoning field. A substantial amount of research and development is conducted in the laboratory through experiments. Experiments often require the execution of mundane but exacting actions, such as filling dozens of test tubes with exact quantities of various liquids. A reliable experiment requires consistency and accuracy in these actions. It is very difficult to reproduce the same experiment multiple times or to scale the experiment to include additional material or steps.

In the prior art, this task often would be performed by a person, which is a tedious and often error-prone endeavor. FIG. 1 depicts a top-view of a prior art configuration used in a typical laboratory. Rack 100 holds a plurality of wells 110 (such as test tubes). The user can manually add one or more liquids to one or more of the wells 110 as part of an experiment. As can be seen in this example, two of the wells 110 contain liquid that was placed there by a user (dark black solidly filled circles).

The prior art also includes certain automated devices that can perform the measuring and mixing of liquids, such as a robot currently offered by manufacturer Opentrons. These prior art devices leverage the technology of 3D printers. FIG. 2 depicts a side-view of one type of prior art robot 200. Robot 200 comprises frame 210, cross-bar 220, head 230, pipette 240, floor 250, and controller 270. Frame 210 and cross-bar 220 can be considered as one type of chassis. Head 230 can move in the “Y” direction along cross-bar 220, and head 230 and cross-bar 220 can move in the “X” direction along frame 210. Pipette 240 can move in the “Z” direction towards floor 250 or away from floor 250.

However, these prior art devices, such as robot 200, are difficult to program and require the user to understand a programming language or an arcane set of instructions or control signals specific to the device. Operation is difficult and tedious because a person either needs to manually input the location of each object or is limited to using equipment that is designed specifically for the device, such as a rack with specific types and numbers of wells and reservoirs. Moreover, these prior art devices do not have the ability to detect a foreign or unknown object (such as a user's hands, or a fallen pipette), or to determine if the material to be transported is absent, if the material to be delivered is not present in sufficient quantity, or if the quantity of material to be delivered is not correct, and the prior art devices would keep operating even if a new object appeared on the workbench, which might result in an injury or broken materials, both of which could compromise the underlying experiment.

What is needed is an improved automated, robotic device for use in the laboratory that is easier to program, that can accommodate a typical laboratory workbench and a range of different materials, that can reproduce the same experiment any number of times with complete accuracy and consistency, that can scale to include additional materials or steps, and that can detect the introduction of a foreign or unknown object onto the workbench or other situations requiring user attention.

### SUMMARY OF THE INVENTION

The invention comprises an automated robotic device that can draw liquid from one or more reservoirs and deposit the liquid into one or more wells. The device can discard a used pipette tip and add on a new pipette tip. The device is equipped with machine vision which allows it to identify and categorize all objects on a workbench and to determine if a foreign or unknown object has entered the workbench during operation and to issue an alert. The device is equipped with additional optical sensors (including basic cameras) and/or pressure touch sensors on pipettes that will allow for the monitoring of material levels in wells. The device can be programmed using natural language instructions, which are translated into a middleware language and then compiled into device-specific control instructions. The device can reproduce the same experiment any number of times, and it can scale to include additional materials or steps.

The features and advantages described in this summary and the following detailed description are not all-inclusive. Many additional features and advantages will be apparent to one of ordinary skill in the art in view of the drawings and specifications.

### BRIEF DESCRIPTION OF THE DRAWINGS

FIG. 1 depicts a prior art rack containing a plurality of wells.

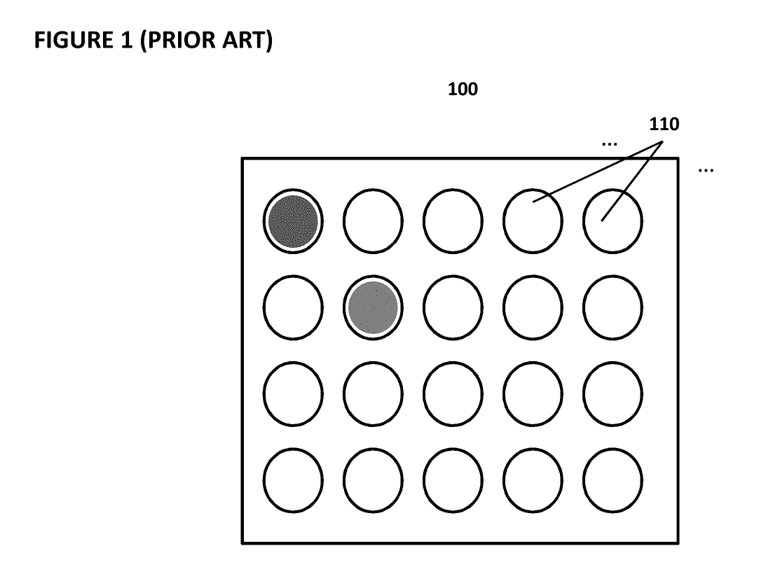

FIG. 2 depicts a prior art automated robotic device.

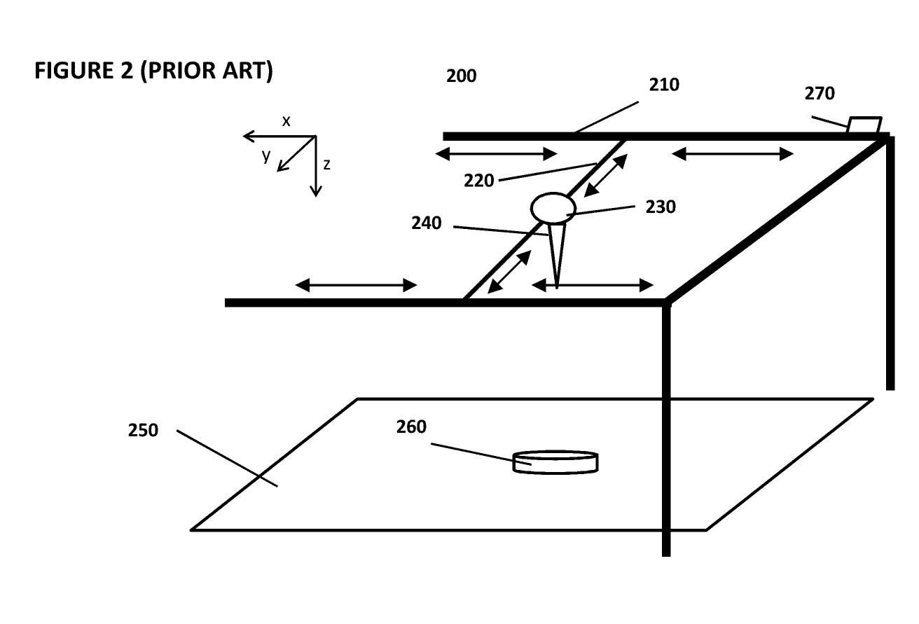

FIG. 3 depicts an embodiment of an automated robotic device.

FIG. 4 depicts a workbench to be used with the automated robotic device of FIG. 3.

FIG. 5 depicts computing devices for use with an embodiment of an automated robotic device.

FIG. 6 depicts the calibration process and the creation of workbench objects.

FIG. 7, in summary, depicts a method of converting instructions in natural language into an intermediate language and then into a device-specific control language.

FIG. 8 depicts a method of converting instructions in natural language into an intermediate language and then into a device-specific control language.

FIG. 9 depicts a method of using an embodiment of an automated robotic device.

FIG. 10 depicts a method of detecting a foreign or unknown object in the workbench and issuing an alert.

FIG. 11 depicts a method of determining if a well is full and issuing an alert.

### DETAILED DESCRIPTION OF THE PREFERRED EMBODIMENTS

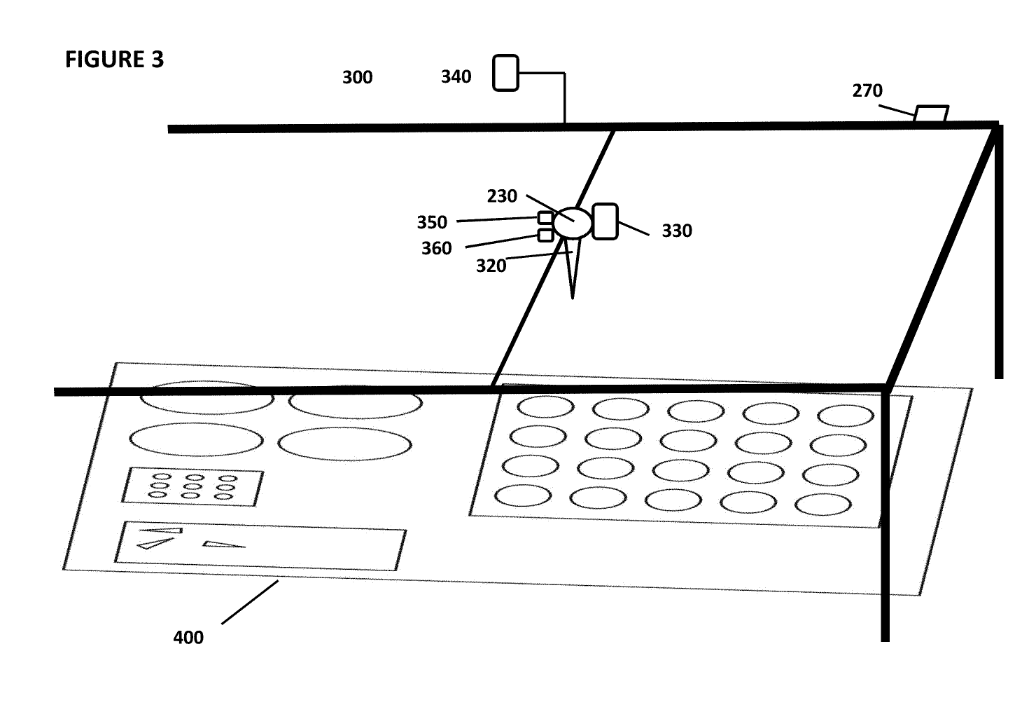

FIG. 3 depicts an embodiment of an automated robotic device 300. In this example, automated robotic device 300 uses certain components and technologies from prior art robot 200, such as frame 210, cross-bar 220, head 230, floor 250, and controller 270. However, certain modifications are made. Stationary camera 340 is coupled to frame 210, mobile camera 330 is coupled to head 230, and pipette 240 is replaced with pipette 320. Stationary camera 340 and mobile camera 330 are exemplary, and one of ordinary skill in the art will appreciate that any number of cameras can be used. Optical sensor (laser, infrared, visible-light sensor) or other sensor 350, which can be a low-grade camera, is attached to head 230 or to an appendage on head 230 to monitor the level of liquid in pipette 320 through a meter window on pipette 320. Touch or pressure/force sensor 360 is attached to pipette 320 to help measure the level of liquid in pipette 320 in conjunction with optical sensor 350. Touch or pressure/force sensor 360 will indicate if the plunger is flush and checks the operational efficiency of pipette 320 by checking contact and measuring the delivery pressure over the time of delivery and checking against an ideal profile. Finally, workbench 400 is placed on floor 250.

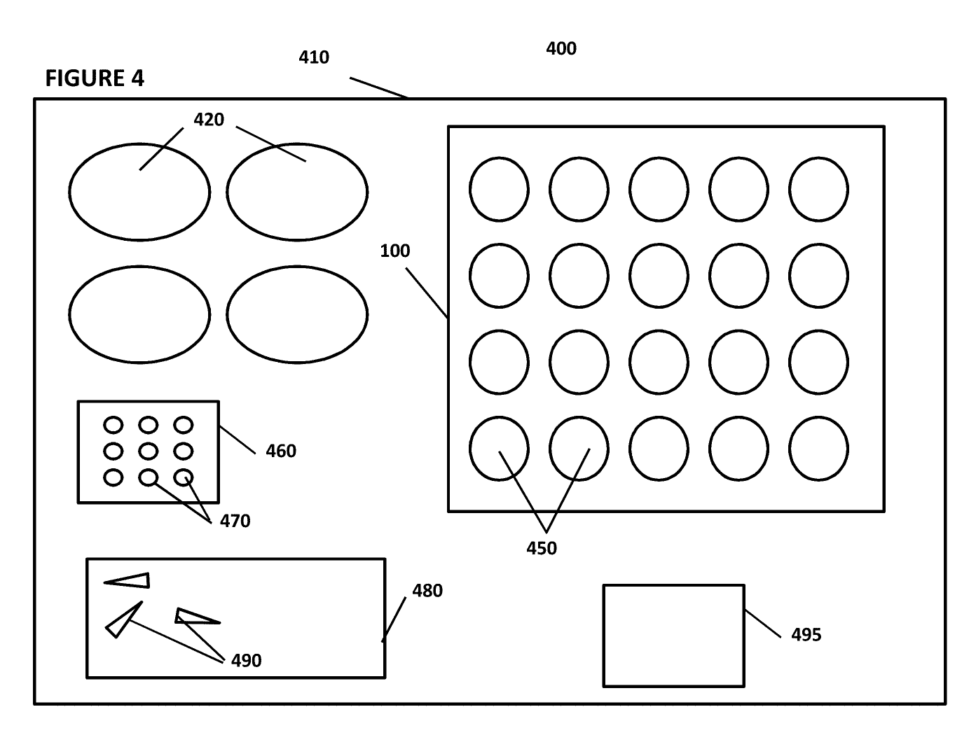

FIG. 4 depicts an embodiment of workbench 400. Workbench 400 comprises container 410, rack 100, wells 450 (such as test tubes), reservoirs 420 (such as test tubes or beakers), container 460, pipette tips 470, container 480, and discarded pipette tips 490. Device 495 also is depicted. Device 495 can be any other device that is useful to the work being performed on workbench 400, such as a centrifuge.

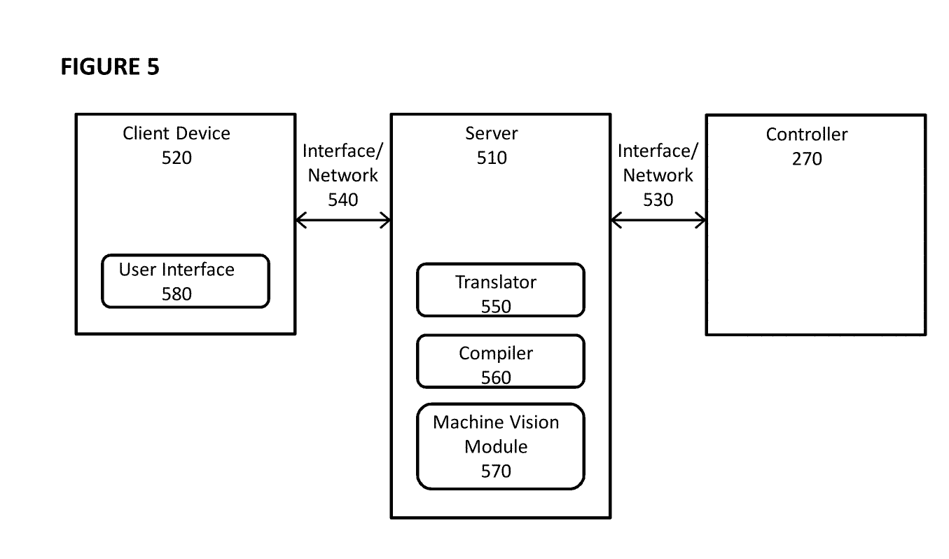

FIG. 5 depicts additional hardware components of the embodiments. Server 510 is coupled to controller 270 over interface/network 530. Optionally, client device 520 is coupled to server 510 over interface/network 540. Alternatively, server 510 can provide the functionality described herein for client device 520. Server 510 is a computing device comprising one or processors, main memory, non-volatile storage, and a network interface. Client device 520 also is a computing device comprising one or processors, main memory, non-volatile storage, and a network interface.

Server 510 operates translator 550 and compiler 560 (discussed below), as well as machine vision module 570. Machine vision module 570 obtains image and video data captured by stationary camera 330 and mobile camera 340 and performs image recognition algorithms. Client device 520 provides user interface 580.

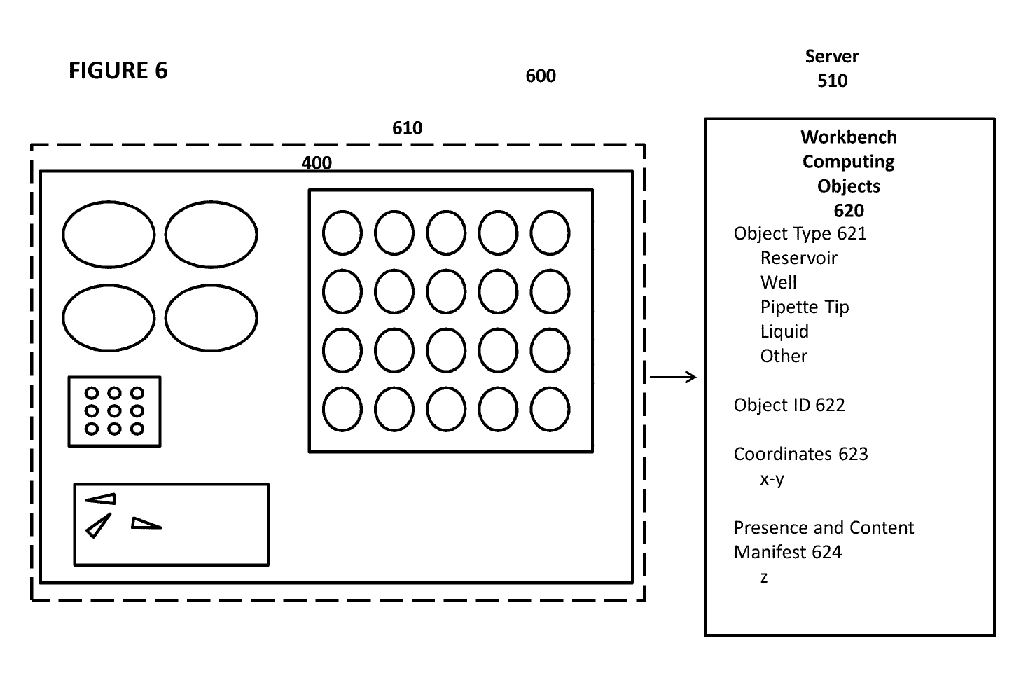

FIG. 6 depicts configuration process 600. During configuration process 600, in one embodiment, stationary camera 340 and/or mobile camera 330 capture top-view image 610 of workbench 400. Controller 270 sends image 610 to server 510 over interface/network 530. Machine vision module 570 executed by server 510 processes image 610 and discerns the boundaries of each physical object on workbench 400. Machine vision module 570 can then perform an image recognition algorithm to discern the identity of each physical object (e.g., well, reservoir, etc.), or it can generate user interface 580 on a display on client device 520 to allow the user to identify each physical object. The objects can be either clear (transparent) or opaque-to-light plastic.

Server 510 generates a computing object for each physical object. The physical objects in work bench 400 correspond to workbench computing objects 620. In one embodiment, each computing object has an object type 621, such as reservoir, well, pipette tip, liquid, and other. Each computing object also can be assigned an Object ID 622 (which is a unique identifier for the object). Coordinates 623 can be captured for the boundaries and/or the middle of the physical object, and the presence and the content manifest 624, such as depth, of any liquid in the object can be ascertained, for example, by using a laser, infrared sensor, or other sensor.

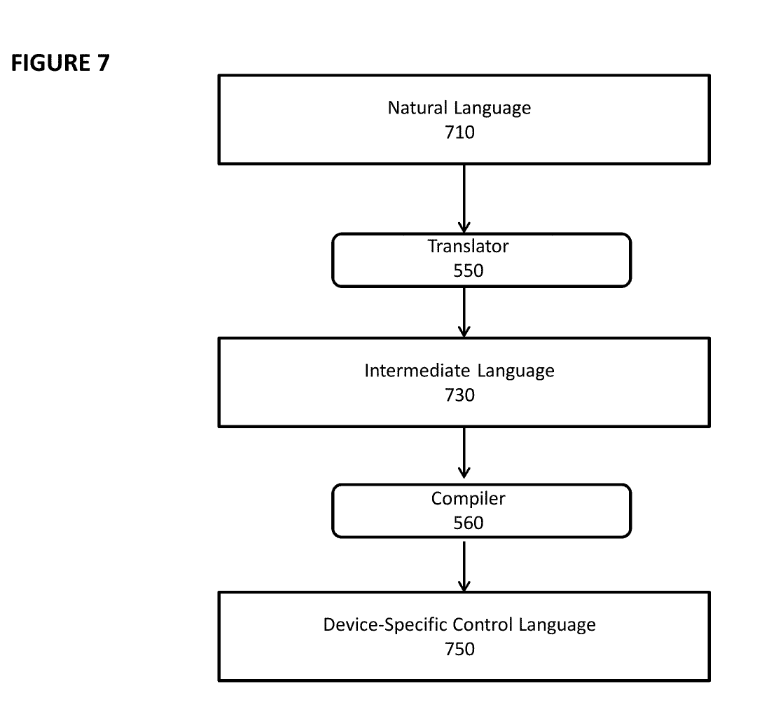

FIG. 7 depicts another aspect of the embodiments of the invention. The user can program automated robotic device 300 using natural language 710 and user interface 580 provided by server 510. Examples of the available commands in natural language 710 are shown in Table 1:

TABLE 1
NATURAL LANGUAGE COMMANDS

| Natural Language | | |
|---|---|---|
| Command | Purpose | Example of Usage |
| Add <Material A> | Aspirate Material | Add “DNA sample” |
| to <Well B> | A in Well B | to “Plate 1 Well A2” |
| Mix <Material A>, | Mix material A to | Mix “Water”, |
| <Material B>, . . . | Z together in a | “TAQ” and “DNTP” |
| <Material Z> | robot specified (not | together |
| together | user specified) well. | |
| <Operator> to create | Any <Operator> | Centrifuge for 10 min |
| <Material A> | creates the new | at 13,000 rpm to |
| | material called | create supernatants |
| | material A | |

With reference again to FIG. 7, the user enters commands using natural language 710 using server 510 or client device 520. For example: “Fill all wells with 1 cc of liquid from Reservoir 1 and 2 cc's of liquid from Reservoir 2.” Translator 550 (which is software code executed on server 510 or client device 520) translates the natural language commands into commands in intermediate language 730. Compiler 560 (which is software code executed on server 510, and which is similar to a device driver for PC peripherals) then translates the commands in intermediate language 730 into device-specific control language 750. This is the language that automated robotic device 300 uses.

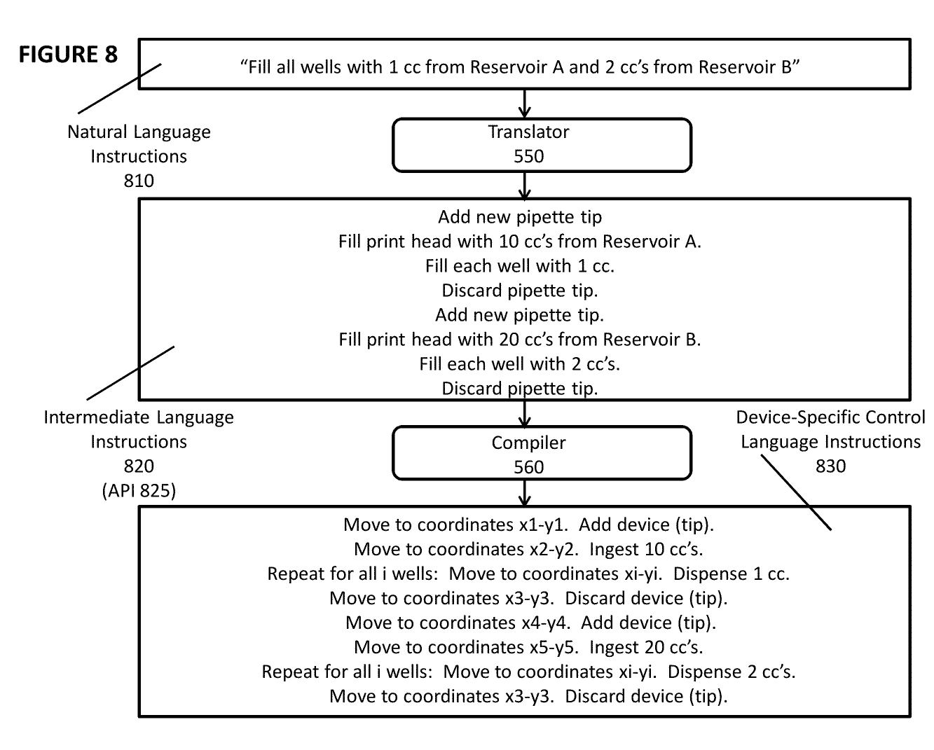

FIG. 8 shows an example of the method of FIG. 7. Here, the user enters natural language instructions 810 using a user interface of server 510 or client device 520. Those natural language instructions 810 are translated by translator 550 into intermediate language instructions 820, and then translated further by compiler 560 into device-specific control language instructions 830. Intermediate language instructions 820 form the essential application programming interface (API) 825. Table 2 contains exemplary API commands and functions that provide the core functionality of the system:

TABLE 2
API COMMANDS AND FUNCTIONS

| API Command | Function |
|---|---|
| Move(x=None,y=None, | Move the pipette head to the given position; |
| z=None): return(None) | used for relative and absolute positioning. |
| PipetteOrdered( pipette, | Performs series of pipetting actions where |
| sourceWell_pair_AmtToPull, | given pairs are ordered, and hence executed in |
| destinationWell_pair_AmtToRelease):return(None) | the given priority order. |
| | sourceWell_pair_AmtToPull defines a list of |
| | pairs of the format “(source well, amount to |
| | pull from this well)” |
| | destinationWell_pair_AmtToRelease defines a |
| | list of pairs of the format−> (destination well, |
| | amount to release to this well). This is a |
| | compound instruction with several inbuilt steps. |
| WorkbenchObjectManager(probe, all) | A probing function to investigate the state of |
| | the workbench. In response, call will identify |
| | all present objects replete with overall shape |
| | and form specifications and also marks the |
| | absence or presence of contents therein (liquid |
| | in wells). A complementary call will set the |
| | workbench object in desired manner and also |
| | selected regions can be probed. |
| SensorManager(probe, all) | The call will return the operational state of all |
| | sensors including the stationary and mobile |
| | optical sensors or cameras and other sensors as |
| | added. A complementary call will “set” the |
| | state of sensors and also selected sensors can |
| | be probed. |

A very skilled and trained bioinformatics programmer who wishes to not use natural language instructions 810, can instead provide instructions in this intermediate language which can be directly translated into device-specific control language 830. Device-specific control language instructions 830 are in the language understood by controller 270. This language might be specific to controller 270, much like a device driver on a PC might be specific to a certain brand and type of peripheral. Notably, if a different controller 270 or automated robotic device 300 is used, the same intermediate language instructions 820 can be utilized, and compiler 560 can compile those instructions into a device-specific control language that is suitable for the different controller or automated robotic device.

Thus, intermediate language 730 and intermediate language instructions 820 are device-independent and therefore can be viewed as middleware. Natural language 710 also is device-independent.

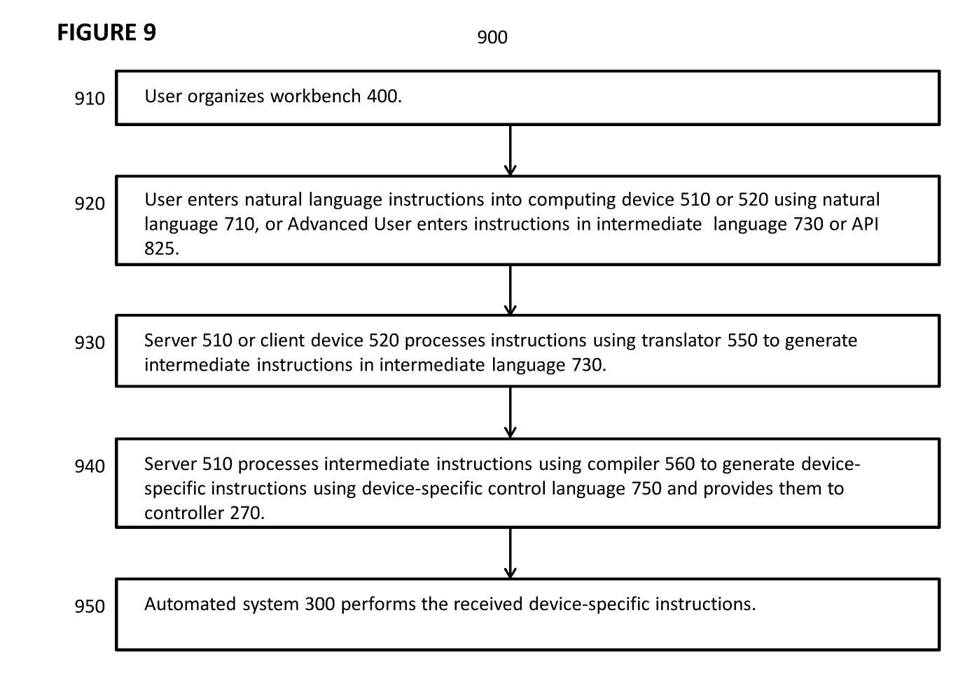

FIG. 9 depicts a method utilizing automated robotic device 300. User organizes workbench 400 (step 910). User enters natural language instructions into server 510 or client device 520 using natural language 710, or Advanced User enters instructions in intermediate language 730 or API 825. (step 920). Server 510 or client device 520 processes instructions using translator 550 to generate intermediate instructions in intermediate language 730 (step 930). Server 510 processes intermediate instructions using compiler 560 to generate device-specific instructions using device-specific control language 750 and provides them to controller 270 (step 940). Compiler 560 makes use of any object detected by machine vision module 570 for mapping the physical location of the object to the real coordinates. These real coordinates will appear in the device-specific control language that is generated by compiler 560. Automated robotic device 300 performs the received device-specific instructions (step 950).

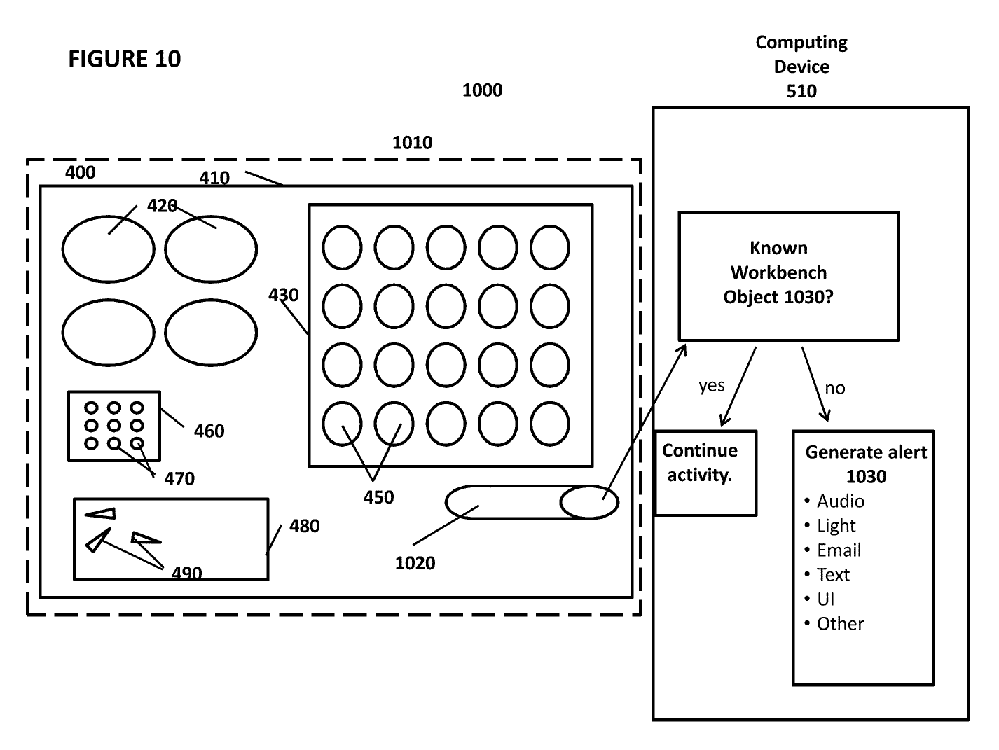

FIG. 10 depicts method 1000 for detecting a foreign or unknown object. Stationary camera 340 and/or mobile camera 330 periodically capture top-view image 1010 of workbench 400. Controller 270 sends the image to server 510 over interface/network 530. Machine vision module 570 processes image 1010 and discerns the boundaries of each physical object on workbench 400. Server 510 compares each discerned object against the set of objects that have already been identified. If the object is known, then it examines the next object and activity otherwise continues. If the object is not known, then computing device generates alert 1030.

In this example, a new physical object 1020 has appeared on workbench 400. Physical object 1020 might be a user's hand, a piece of equipment that has broken or fallen (such as a pipette tip), or another physical object altogether. Server 510 will detect physical object 1020 and will determine that its coordinates do not match any known object. Server 510 then will generate alert 1030. Alert 1030 can include audio (e.g., a loud beep), light (e.g., a blinking red light), an email to the user, a text message (e.g., SMS or MMS message) to the user, other output on a user interface device (such as a text alert on the display), or other means of obtaining the user's attention. The user optionally can then stop automated robotic device 300 to remove physical object 1020.

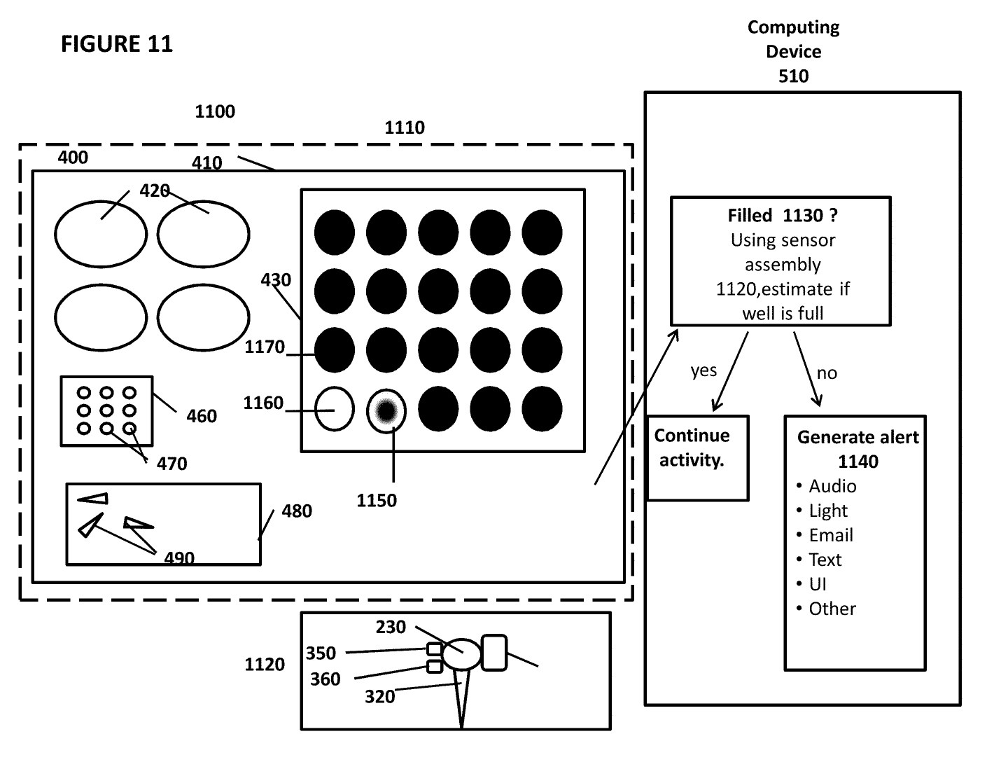

Other events that require user attention also can be identified and an alert generated. For example, in FIG. 11, using the sensor assembly of 1120, it can be estimated if a well, reservoir, other container is full or if the required amount is not dispensed. In this example, well 1150 is partially filled, well 1160 is empty, and other wells are filled (dark circles), including well 1170. If the system is instructed to add liquid to a full well, such as well 1170, or add liquid to a well that will cause it to overflow, server 510 will generate alert 1140. Similarly, the absence of requisite amount of material in well 1150 can cause server 510 to generate similar alert. As with alert 1030 in FIG. 10, alert 1140 can include audio (e.g., a loud beep), light (e.g., a blinking red light), an email to the user, a text message to the user (e.g., SMS or MMS message), other output on a user interface device (such as a text alert on the display), or other means of obtaining the user's attention. The user optionally can then intervene to change the instructions or to alter the wells present on workbench 400.

One of ordinary skill in the art will appreciate that other exception handling mechanisms can be implemented by server 510.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A robotic device for providing automated laboratory functions, comprising:
a chassis;
a workbench positioned within the chassis;
a movable head mounted to the chassis and vertically suspended over the workbench;
a pipette mounted on the movable head, the pipette capable of ingesting and dispensing liquid;
a first camera mounted to the chassis;
a second camera moveable in conjunction with the movable head;
a controller coupled to the movable head; and
a machine vision module for analyzing images captured by one or more of the first camera and the second camera, wherein the controller is configured to stop movement of the movable head when the machine vision module detects an unknown object on the workbench or if a liquid level in a well is estimated to be incorrect.

2. The robotic device of claim 1, wherein the robotic device is capable of adding a pipette tip to the pipette and discarding a pipette tip from the pipette.

3. The robotic device of claim 1, wherein the machine vision module is configured to identify each object on the workbench and associate each object with physical coordinates within the workbench.

4. The robotic device of claim 1, wherein the robotic device further comprises one or more of an optical sensor and one or more touch or pressure sensor for measuring the amount of liquid in the pipette.

5. The robotic device of claim 1, wherein the robotic device is further configured to generate an alert when the machine vision module detects an unknown object on the workbench or when implementation of an instruction will cause a well or reservoir to overflow or will not allow the complete filling of a well.

6. The robotic device of claim 5, wherein the alert comprises an email or text message.

7. The robotic device of claim 1, wherein the controller controls the movable head using a device-specific control language.

8. A system for providing automated laboratory functions, comprising:
a robotic device, comprising:
a chassis;
a workbench positioned within the chassis;
a movable head mounted to the chassis and vertically suspended over the workbench;
a pipette mounted on the movable head; and
a controller coupled to the movable head; and
a computing device coupled to the controller, the computing device comprising a compiler for receiving a set of intermediate language instructions and generating a set of device-specific control instructions that are executable by the controller;
wherein the set of device-specific control instructions cause the robotic device to perform one or more of: adding a pipette tip to the pipette; discarding a pipette tip from the pipette; ingesting liquid into the pipette; and dispensing liquid from the pipette.

9. The system of claim 8, wherein the robotic device further comprises a first camera mounted to the chassis and a second camera moveable in conjunction with the movable head, and the computing device further comprises a machine vision module for analyzing images captured by one or more of the first camera and the second camera and the controller is configured to stop movement of the movable head when the machine vision module detects an unknown object on the workbench.

10. The system of claim 8, wherein the computing device further comprises a translator for receiving a set of natural language instructions and generating the set of intermediate language instructions.

11. The system of claim 8, further comprising a client device for receiving the set of natural language instructions from a user interface.

12. The system of claim 8, wherein the robotic device is capable of adding a pipette tip to the pipette and discarding a pipette tip from the pipette.

13. The system of claim 9, wherein the machine vision module is configured to identify each object on the workbench and associate each object with physical coordinates within the workbench.

14. The system of claim 8, wherein the robotic device further comprises one or more of an optical sensor and a touch sensor for measuring the amount of liquid in the pipette.

15. The system of claim 9, wherein the controller is further configured to generate an alert when the machine vision module detects an unknown object on the workbench or when implementation of an instruction will cause a well or reservoir to overflow or underflow.

16. The system of claim 15, wherein the alert comprises an email or text message.

17. The system of claim 8, wherein the controller controls the movable head using a device-specific control language.

18. A method of providing automated laboratory functions, comprising:
receiving, by a client device, a set of natural language instructions;
transmitting, by the client device, the set of natural language instructions to a computing device;
translating, by the computing device, the set of natural language instructions into a set of intermediate instructions;
compiling, by the computing device, the set of intermediate instructions into a set of device-specific instructions executable by a controller of a robotic device;
transmitting, by the computing device, the set of device-specific instructions to the controller; and
executing, by the controller, the set of device-specific instructions to perform automated laboratory functions using a robotic device comprising a movable head and a pipette coupled to the movable head, the automated laboratory functions comprising one or more of: adding a pipette tip to the pipette; discarding a pipette tip from the pipette; ingesting liquid into the pipette; and dispensing liquid from the pipette.

19. The method of claim 18, further comprising:
identifying, by the computing device, an unknown object near the robotic device;
generating, by the computing device, an alert in response to the identifying step.

20. The method of claim 19, wherein the generating step comprises sending an email or text message.
